(19) United States
(12) Patent Application Publication
(10) Pub. No.: US 2009/0204507 A1
(43) Pub. Date: Aug. 13, 2009

(54) Method and system for discovering and generating an insight via a network

(75) Inventors: William Roy Cockayne, San Francisco, CA (US); Tammy Lee Carleton, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Change Research Incorporated, San Francisco, CA (US)

(21) Appl. No.: 12/367,324

(22) Filed: Feb. 6, 2009

Related U.S. Application Data
(63) Continuation of application No. 11/066,979, filed on Feb. 26, 2005, now abandoned.
(60) Provisional application No. 60/548,067, filed on Feb. 26, 2004.
(60) Provisional application No. 61/197,861, filed on Oct. 31, 2008.

(51) Int. Cl. G06Q 30/00; G06N 3/12; G06Q 40/00; G06F 15/16

(52) U.S. Cl. 705/26; 706/13; 705/39; 707/E17.108; 709/204; 709/203

(57) ABSTRACT

A method and system (60, 70, 80, 90, 100, 110, 120) for discovering and generating a new insight via a network. An user intentionally enters a piece of data, information, or knowledge into a client system and sets its level of sharing. With no further action by the user the data, information, or knowledge is then transferred across a network until a second piece of data, information, or knowledge, is encountered on a client or server system. The two pieces of data, information, or knowledge, are compared using multiple analytical methods in order to discover the level of matching. A new insight is generated when the level of matching is considered sufficient. The match level and both pieces of data, information, or knowledge, are then packaged as a new insight. This insight package is then transferred across the network to the system of both originating users. The insight is then presented to the users for further action.

### CROSS-REFERENCES TO RELATED APPLICATIONS

This application claims priority to U.S. Provisional Application No. 60/548,067 filed Feb. 26, 2004, and is hereby incorporated by reference in its entirety for all purposes.

### OTHER REFERENCES

Cockayne, W. (2005) “A study of the formation of innovation ideas in informal network”, Stanford University, dissertation, Stanford, Calif.

Cycorp, Inc. White papers, examples, demonstrations, and software code. Austin, Tex.

drfish list (1999-2005) a collection of papers, articles, and talks spanning multiple knowledge areas and including all reference to authors, publication date, and source of the materials. Dr. William Cockayne. San Francisco, Calif.

Koestler, A. (1964) The act of creation. Pan Books Ltd. London, UK.

Ohsawa, Y. and McBurney, P. (eds.) (2003) Chance discovery. Springer. NY, N.Y.

Research and Technology Executive Council. (2001) “Idea sensing efficiency: Practices for broadening access to external technology innovations.” Corporate Executive Board. Washington, D.C.

WordNet. White papers, examples, demonstrations, and software code. Princeton University Cognitive Science Laboratory. Princeton, N.J.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

The present invention relates generally to a networked insight discovery platform. More particularly, the present invention provides a technique including a method for discovering and generating insights using a network. Insights can be derived from pieces of data, information, knowledge, Pre-ideas, half-formed thoughts, ideas, or thoughts, or any combination thereof, that are regional, national, or global, or any combination thereof, and which may exist in a multitude of homogenous or heterogeneous fields. In an exemplary embodiment, the sources include pre-ideas (e.g., half-formed thoughts, ideas, thoughts, data, information, or knowledge) generated by users using the system and who maintain a long-term knowledge base in the network. Merely by way of example, the present insight technique can also be applied to fields such as business applications, electronic commerce, finance including venture capital, biotechnology, nanotechnology, areas of emerging technologies, deep space, foresight, futures, synthetical systems, systems design, human-centric computing, artificial intelligence, information retrieval and organization, knowledge discovery, emergence, invention, innovation, and the like.

Insight discovery techniques have been around for many years. In the early days, people often discovered a new insight by meeting each other around an office water cooler. Discovering insights around a water cooler was somewhat successful, but a limited amount of information could be transferred between users during the brief period that each person filled up their cup. An individual could, after brief platitudes about the weather, mention only a limited number of new pre-ideas (e.g., half-formed thoughts, ideas, thoughts, data, information, or knowledge) that were in his or her working memory. Additionally, the other person, after responding to the brief platitudes, would also be able to share a limited number of pre-ideas (e.g., half-formed thoughts, ideas, thoughts, data, information, or knowledge) which where, again, drawn from personal working memory. Furthermore, each person had to actively listen to the other speaker in order to compare the pre-ideas (e.g., half-formed thoughts, ideas, thoughts, data, information, or knowledge) being shared, in an attempt to compare said pre-ideas against any possible pre-ideas (e.g., half-formed thoughts, ideas, thoughts, data, information, or knowledge) that he or she personally possessed. If an insight or insights were discovered by one of the persons it then had to be shared verbally or possibly by being written on a whiteboard, if one could be found. Needless to say this complex and time-consuming process often failed because of the limits of human memory, limits in individual abilities for comparison, the limits of human proactiveness, and the limited amount of time offered when filling up one's cup.

Many individuals attempted to increase their opportunities for insight discovery around water coolers by spending excessive amounts of time standing around the water cooler, spending time in cafes, or attending brainstorming sessions. In addition to the limits of human memory, abilities for comparison, proactiveness, and time, these individuals were often unable to bring new pre-ideas (e.g., half-formed thoughts, ideas, thoughts, data, information, or knowledge) because they spent too much time at the water cooler waiting or in conversation at the café or attempting to brainstorm new ideas, and not enough time reading, thinking, collecting, or reflecting.

Companies realized that this process of insight discovery around a water cooler was often the basis for creativity, invention, and innovation, which leads to new products, processes, and ultimately profits. Companies attempted to increase the opportunities for insight discovery around water coolers by architecting new buildings that had more watercoolers and their equivalent—coffee machines, cafeterias, general meeting areas with comfortable chairs, and common spaces between offices—or by creating a culture of wherein these serendipitous encounters are encouraged, or by holding company-wide events where the water cooler encounter was artificially created, such as in brainstorms. In all situations the limits of human memory, abilities for comparison, proactiveness, and time were still existent.

Companies and individuals began to adopt physical tools in an attempt to remove these limitations; one well-known tool are sticky notes. Sticky notes, along with small pads of paper, whiteboards, personal voice recorders, and the like, were intended to help remove the limitations of human memory. Individuals could write down any pre-ideas (e.g., half-formed thoughts, ideas, thoughts, data, information, or knowledge) on a sticky note. While sticky notes sometimes helped individuals to capture more of their pre-ideas (e.g., half-formed thoughts, ideas, thoughts, data, information, or knowledge) they offered no help in terms of limits of abilities for comparison, proactiveness, or time.

Also, companies and individuals attempted to use social networks, and tools built around social network theory, in order to remove these limitations. Such tools attempted to measure the communication channels using emails or find shared expertise between users based on their stated or inferred expertise. One failure of these tools was the reliance on communicated information, missing the breadth and depth of pre-ideas (e.g., half-formed thoughts, ideas, thoughts, data, information, or knowledge), which existed in the individuals within the social network. Further, these tools did not increase the opportunity for generating insights around the individuals' pre-ideas (e.g., half-formed thoughts, ideas, thoughts, data, information, or knowledge).

Therefore what is needed is an insight discovery technique that overcomes the problems and disadvantages associated with conventional limits of human memory, limits in individual abilities for comparison, limits of human proactiveness, and the limited amount of time offered when filling up one's cup.

### SUMMARY OF THE INVENTION

According to the present invention, a technique including a method for networked insight discovery is provided. In an exemplary embodiment, the present invention provides a technique for allowing users to collect and manage pre-ideas (e.g., half-formed thoughts, ideas, thoughts, data, information, or knowledge) through an interface into a client system wherein, with no further action on the part of the user, the client system transfers the pre-ideas to a server system which includes pre-ideas from a multitude of other users, wherein the server system compares all of the pre-ideas from all of the users using a multitude of analytic tools, methods, and algorithms, wherein if the server system discovers a match between two pre-ideas an insight is generated including references to or inclusion of the two pre-ideas, references to the originating users, the analytics applied, and the match results, which are then stored on the server, and which are further transferred to the client system, whereupon the insight is presented to the user through the interface for review, allowing the user to accept, defer, or ignore the insight. By way of the present technique, numerous client and server systems will be distributed and used throughout a selected region or nationally, globally, and/or extraterrestrially.

In an preferred embodiment, the present invention provides a method for using algorithms for comparison that are based on specific knowledge areas including but not limited to bioengineering, pharmaceuticals, nanomaterials, business practices, organizational learning, and the like. The method includes steps of developing said algorithms using machine learning, knowledge bases, contextual knowledge systems, data mining, human development of rules, or through the purchase on an existing solution from another company.

The method includes steps of providing a client system (e.g., a software application, a webpage, a mobile device application, a mobile phone application, a server-based interface, a database interface), which has a user interface, storage database, an insight database, and a network interface. The method also includes transferring data, including pre-ideas and insights, using physical contact (e.g., floppy disk, CD-ROM, DVD, memory stick, USB memory device, touch data transfer devices), wired network (e.g., copper, Ethernet, deep sea cables, phone lines, CAT5, the Internet) or wireless network (e.g., a radio frequency network, a cellular network, a paging network, an infrared network, the Internet), either in-the-clear or at multiple levels of security. Furthermore the network could include members who are never connected at the same time, who are unknown to each other, who communicate only through a server, and/or who operate in a peer-to-peer network that may include multiple levels of peering and/or servers as members of the network. The information is stored in databases and/or in a memory storage device; and is outputted as pre-ideas or insights for the user through the user interface. The pre-ideas and insights are selected from text, graphic, a banner, audio, video, or animation, three- or higher-dimensional data types, holograms, or any combination thereof In specific embodiments, the transfer of pre-ideas, generation of insights, and transfer of insights occurs at non-peak hours, which can reduce costs of using the client systems, server systems, and networks.

In a specific embodiment each user must register with the client and server system using a globally distinct user identification, which can either be generated and managed by the system or through leveraging an existing global user identification generated by another system and accessible to the client and server system. In a specific embodiment said registration may be used to secure, verify, sign, and/or encrypt the storage and transfer of pre-ideas and insights. Furthermore, there may be different manner of users, including but not limited to administrative accounts, preferred users, premier users, groups, teams, companies, reporters, trusted sources, RSS feeds, magazines, advertisers, research firms, data aggregators and/or others. Different users may possess differing levels of security, authority, ability to; generate pre-ideas, propagate pre-ideas, receive insights, access various analytics either locally or on the server, receive updates to analytics, communicate with other users, receive services for free, receive services for payment, perform services for payment, and other actions obvious to a practitioner.

In a preferred embodiment, the present invention provides a method for creating insights proactively, without the need to begin the process, initiate a search, find other users, listen to other users' pre-ideas, communicate pre-ideas, compare other users' pre-ideas, generate insights, communicate insights, and/or engage in any manner of search process that entails initiation or active involvement by the user. The system is proactive in terms of the transfer, analysis, comparison, discovery, generation, delivery, notification, and presentation of pre-ideas (e.g., half-formed thoughts, ideas, thoughts, data, information, or knowledge) or inferences from the structured and unstructured data.

In an alternate embodiment, the present invention provides a method for creating insights based on pre-ideas that are created by users in different fields of research or practice, including but not limited to pre-ideas that are cross-team, cross-disciplinary, interdisciplinary, transdisciplinary, cross-organizational, cross-business, across fields, cross-country, and/or cross language. Furthermore, the system may perform the comparisons on behalf of the user, who possesses no prior knowledge of the other fields, languages, or methods.

In a preferred embodiment, the present invention provides a method for creating insights that are utterly novel, based on two pre-ideas that have never been connected together before. Furthermore, said insight may be patentable by the users of the originating pre-ideas and the server system or its business proxy.

In a preferred embodiment, the present invention provides a method for creating insights between two users who have never met before and who have no knowledge of each other. Furthermore, the two users may be in different companies, disciplines, fields of work, areas of knowledge, countries, and/or outer space, including but not limited to planets, space stations, or other space transport or habitation environments.

In an alternate embodiment, the present invention provides a method for offering users and companies the ability to manage pre-ideas and generate insights that can be actively used at an earlier time in the research or innovation process because of the use of pre-ideas. Pre-ideas have the advantage of existing before traditional instances of personal or corporate information that can be written in a white paper, published, presented, and/or managed. Further, analyzing pre-ideas results in insights that are also earlier than insights that are generated from already codified, shareable, published, and/or managed personal or corporate information.

In a preferred embodiment, the present invention provides a method for a user to view, copy, share, review, annotate, update, and create insights from other users' pre-ideas through the user interface on the client system. Furthermore, a user can enter an insight into his insight data store or into another user's insight data store through a multitude of communication methods, including but not limited to, email, instant messenger, SMS, a telecommunications network, a wireless network, a digital network, and/or a terrestrial or extraterrestrial network.

In an alternate embodiment, the present invention provides a method for discovering and generating insights using pre-ideas that are considered outliers, anomalies, unknown unknowns, twinklers, low-probability, very low probability, and/or other ambiguities.

In an alternate embodiment, the present invention provides a method for updating the analytics on a client system or server system from another client or server that possesses newer, more advanced, and/or alternative analytics, when the systems first communicate, at scheduled times, at regular intervals, on request of the user, and/or through other human intervention.

In a preferred embodiment, the present invention provides a method for discovering and generating insights between pre-ideas (e.g., half-formed thoughts, ideas, thoughts, data, information, or knowledge) with different levels of user-defined or system-defined sharing. Furthermore, insights discovered between two pre-ideas of different sharing can be reported to the originating users in different manners, to a superset of users, to a subset of users, or to no originating user.

In a preferred embodiment, the present invention provides a method for discovering and generating insights between a one user's, two users', or a multitude of users' pre-ideas, client systems, servers systems, and/or networks. Furthermore, insights discovered and generated by the system can be used as pre-ideas in the discovery and generation of new insights.

In a preferred embodiment the server system will analyze the pre-ideas in its storage database on a continuous or semi-regular basis.

Numerous advantages or benefits are achieved by way of the present invention over conventional techniques. In a specific embodiment, the present invention provides a manner for a user to receive new insights that overcome conventional limits of human memory, limits in individual abilities for comparison, limits of proactiveness, and the limited amount of time available to humans in a day. The user can enter pre-ideas (e.g., half-formed thoughts, ideas, thoughts, data, information, or knowledge) into the system at any time, and over an extended period of time (hours, days, weeks, years, decades, centuries) which the system will then compare against other users' vast collection of pre-ideas. The user can receive insights related to pre-ideas that are no longer in short-term memory, may no longer be active in the user's actions, and may have been forgotten by the user due to time or biological limits. Additionally, the present invention provides an easy to use and easy to interface for collecting, storing, reviewing, managing, and deleting pre-ideas. Additionally, the present invention provides an exemplary interface for receiving, reviewing, deferring, accepting, denying, or ignoring, insights. Furthermore, the present invention provides extensive time and methods for comparison of pre-ideas through analytics (including, but not limited to, keyword matching, contextual matching, synthetic analysis) which may be outside the abilities of the user, may take more time and effort than the user is willing or able to commit, which may be updated over time, which may be integrated in novel ways to create new emergent insight analytic methodologies. Additionally, the present invention provides for pre-ideas to be shared, transferred, and compared, and insights to be generated, reported to the originating users', and presented for review by the users, without the users involvement; the user does not need to begin the comparison of pre-ideas, generation of insights, and/or transfer of insights from the server systems to the client systems. Furthermore, the present invention provides a method for a user to receive insights that were generated while asleep, on vacation, working on a different piece of work, outside of business hours, while traveling, or in any other manner which is outside of the traditional time boundaries of a conversation focused around the exchange of pre-ideas. Moreover, the present invention should lower costs of sharing pre-ideas and generating insight to a user, a group, and/or a company. Still further, the present invention provides for other applications such as business, finance, personal, and the like. Depending upon the embodiment, one or more of these advantages may exist. These and other advantages are described throughout the present specification and more particularly below.

Other forms, implementations, and methods, advantages and novel features of the present invention will become apparent from the following detailed description of the invention when considered in conjunction with the accompanying drawings, figures, and flow diagrams.

### BRIEF DESCRIPTION OF THE DRAWINGS

FIG. 1 is a simplified block diagram of a client system according to an embodiment of the present invention;

FIG. 2 is a simplified block diagram of the client and server systems in a network according to an embodiment of the present invention;

FIG. 3 is a simplified block diagram of a client system according to embodiments of the present invention;

FIG. 4 is a simplified block diagrams peer client systems in a network according to embodiments of the present invention;

FIG. 5 is a simplified block diagram illustrating methods according to embodiments of the present invention; and

FIGS. 6-12 are simplified flow diagrams illustrating methods according to embodiments of the present invention.

### DESCRIPTION OF THE SPECIFIC EMBODIMENTS

According to the present invention, a technique for discovering and generating a new insight via a network is provided. In an exemplary embodiment, the present invention provides a technique for using advertisements as a source for funding a portion of the user's service. By way of the present technique, numerous client and server systems will be distributed and used throughout a selected geographic region, nationally, or globally. In other embodiments, the present invention provides a novel technique for utilizing only client systems to discover and generate insights in a network.

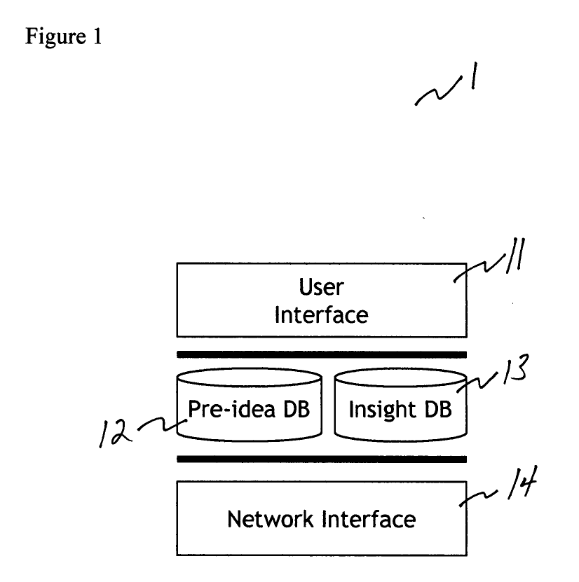

FIG. 1 is a simplified block diagram 1 of a client system according to an embodiment of the present invention. This diagram is merely an example, which should not limit the scope of the claims herein. One of ordinary skill in the art would recognize many other variations, modifications, and alternatives. The diagram 1 includes a variety of features such as a user interface 11, which provides access to a local database 12 for pre-ideas (e.g., half-formed thoughts, ideas, thoughts, data, information, or knowledge) and insight database 13, and a network interface 14. The client system may additionally have a memory storage device, a processor, operating instructions, a wired or wireless receiver or transceiver, display, and input controls.

In a specific embodiment, the client system should have a suitable display. Here, the interface includes a screen of at least 2 inches on a side, 12″ diagonal, a standard webpage, and/or a touch or voice display. Here, the display can be selected from a suitable liquid crystal display (LCD screen), plasma display, cathode-ray tube (CRT), two-handed touch interface, speaker and voice system, headset, or other method of display that outputs visual, tactile, or audio sensory information.

The user interface 11 supports the input of pre-ideas, including the management, modification, forwarding, and/or removal of pre-ideas, which can include textual, image, video, audio, and other data types, which are then stored in the pre-idea database 12. The user interface 11 also supports the addition, modification, or removal of sharing for the pre-ideas. The user interface 11 also supports the addition, modification, or removal of a list of users who should have privileged or modified access to the pre-ideas or insights of the user. The user interface 11 supports the notification, review, management, modification, forwarding, and/or removal of insights, which are stored in the insight database 13. In a specific embodiment, the insights are transferred into the insight database 13 via the network interface 14 in communication with a server, with the user through a variety of message exchanging methods, or with another user through a variety of message exchanging methods. In a preferred embodiment no pre-ideas are ever deleted from any pre-idea database in the network, including all client systems and server systems; pre-ideas that a user chooses to delete are retained in the pre-idea database with an indication that the user chose to delete the pre-idea from the user interface. In an alternate embodiment pre-ideas that are deleted by the user from the user interface and that are retained in the pre-idea database are available to the system for pre-analysis and analysis to discover and generate insights.

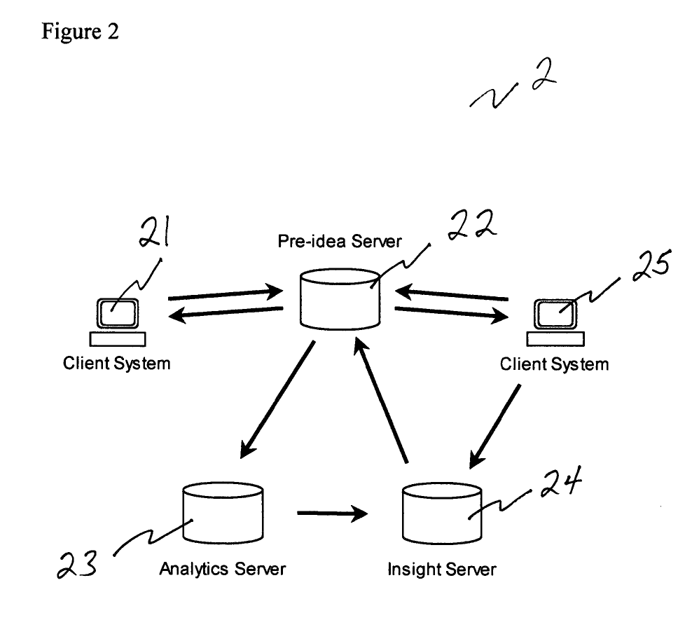

FIG. 2 is a simplified block diagram 2 of a client and server system according to an embodiment of the present invention. The pre-ideas can be viewed by the client system 21. As merely an example, the user views the pre-ideas client system which may include a smart phone, smart pager, or in another form of mobile browser. The pre-ideas on the client system are transferred across a network to the pre-ideas server 22, which is comprised of a network interface and pre-idea database. The pre-ideas server 22 communicates with a multitude of clients of different types, existing anywhere on the planet or in space. A pre-idea is stored on the server in correlation with the originating users, the date of inception and modification, other pre-ideas that said pre-idea has been matched with including the dates, methods of analysis, and follow-on user actions, and the pre-ideas that said pre-idea has been analyzed with and which did not result in a match, including the dates and methods of analysis. The pre-ideas server 22 communicates with the analytics server 23 which may exist on the same physical machine or on another machine. The analytics server stores the analytics, including methods and tools for pre-analyzing, analyzing, and/or post-analyzing the pre-ideas. The analytics can be of multiple types. Pre-ideas stored on the pre-idea server 22 which are matched using the analytics server 23 are stored on the insight server 24 which may exist on the same physical machine or on another machine. The pre-ideas server 22 transfers insights from the insight server 24 to the client system 21. Further details of the present system are provided below. A user can enter an insight into the network 25 from a client system that is stored for other users on the insight server 24.

The present invention also provides techniques for creation, aggregation, modification, formatting, compression, encryption, transfer, wireless transmission, receipt, decompression, verification, processing, storage, display, and removal of the pre-ideas and insights from the client and server. The insight system is primarily composed of a set of backend software data creation and manipulation tools, a backend storage system, such as a database or web server, a set of tools for performing the necessary manipulations of the information for transfer to the client systems and a network for the transfer of the pre-ideas and insights. The client system utilizes the components to operate on the insights to facilitate their display to the user.

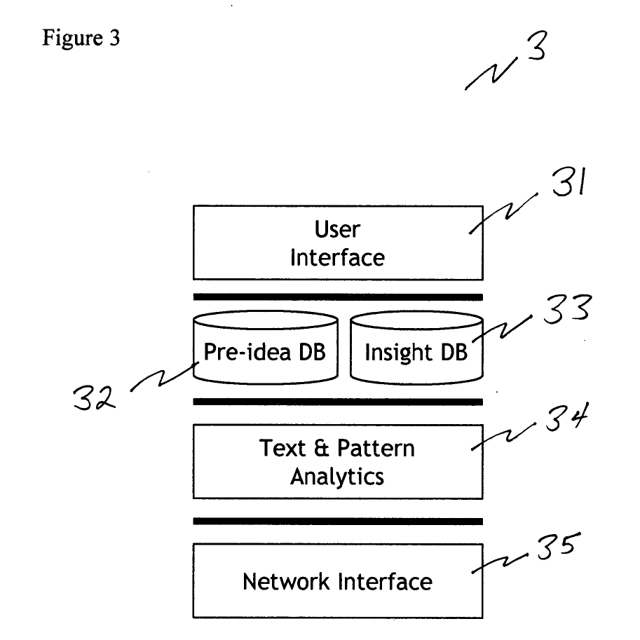

FIG. 3 is a simplified block diagram 3 of a client system according to another embodiment of the present invention. This diagram is merely an example, which should not limit the scope of the claims herein. One of ordinary skill in the art would recognize many other variations, modifications, and alternatives. The diagram 3 includes a variety of features such as a user interface 31, which provides access to a local database 32 for pre-ideas (e.g., half-formed thoughts, ideas, thoughts, data, information, or knowledge) and insight database 33, an analytics system 34, and a network interface 35. The client system may additionally have a memory storage device, a processor, operating instructions, a wired or wireless receiver or transceiver, display, and input controls. The discovery and generation of insights using the user's pre-ideas in the pre-idea database 32 could occur using the analytics 34 and storing any discovered and generated insights in the insight database 33.

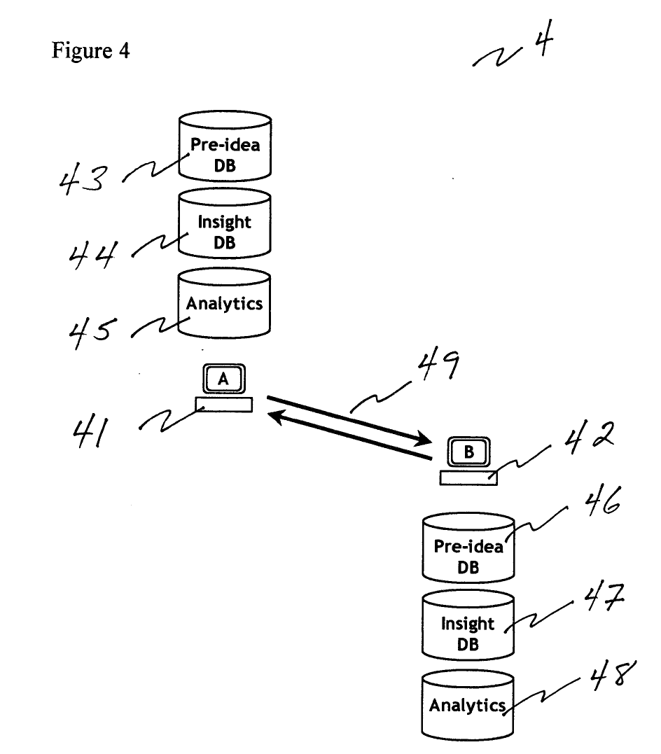

FIG. 4 is a simplified block diagram 4 of a client system according to an embodiment of the present invention. The diagram is merely an example, which should not limit the scope of the claims herein. One of ordinary skill in the art would recognize many other variations, modifications, and alternatives. The users can create pre-ideas via the user interfaces on the two client systems in the network 41, 42. Each client system possesses a pre-idea database 43, 46, insight database 44, 47, and analytics 45, 48. The pre-ideas on the client system 41 are transferred across a network 49 to the client system 42 and stored in the pre-idea database 46. The client systems 41 can then use the local analytics 43 to compare the pre-idea from the other client system 42 and the pre-ideas in its local pre-idea database 48. If any insights are discovered then they are generated and stored in the local insight database 47 and transferred across the network to other client system 41 where the insight can be stored in its local insight database 44. Both client systems can then present the insight to their user via the use interface. The network of course can include a variety of different client systems, each of which with various amounts of memory, displays, and network interfaces, all of which have a local pre-idea database, insight database, some level of local analytics, including no analytics and relying on a remote analytics system. Server systems can also operate as client systems in this network configuration. Server systems can also exist in this configuration and provide additional services such as pre-idea and insight databases that span multiple, non-connected networks, pre-idea and insight databases that are currently offline or otherwise inaccessible to other client systems, pre-idea and insight databases generated by users who are no longer part of the network, or services such as backup, redundancy, additional processing ability for analytics, additional storage space for pre-ideas and insights, additional analytics, for-fee services such as additional analytics, for-fee pre-ideas or analytics, and so on.

Although the above has been described in terms of general hardware and software, many other variations, alternatives, and modifications can exist. For example, any of the functionality above can be further integrated or even separated in terms of hardware. Alternatively, the functionality can be further integrated or even separated in terms of software. Alternatively, the functionality can be further combined in terms of hardware and software. The functionality can also be separated in terms of a combination of hardware and software. Depending upon the application, other variations can exist.

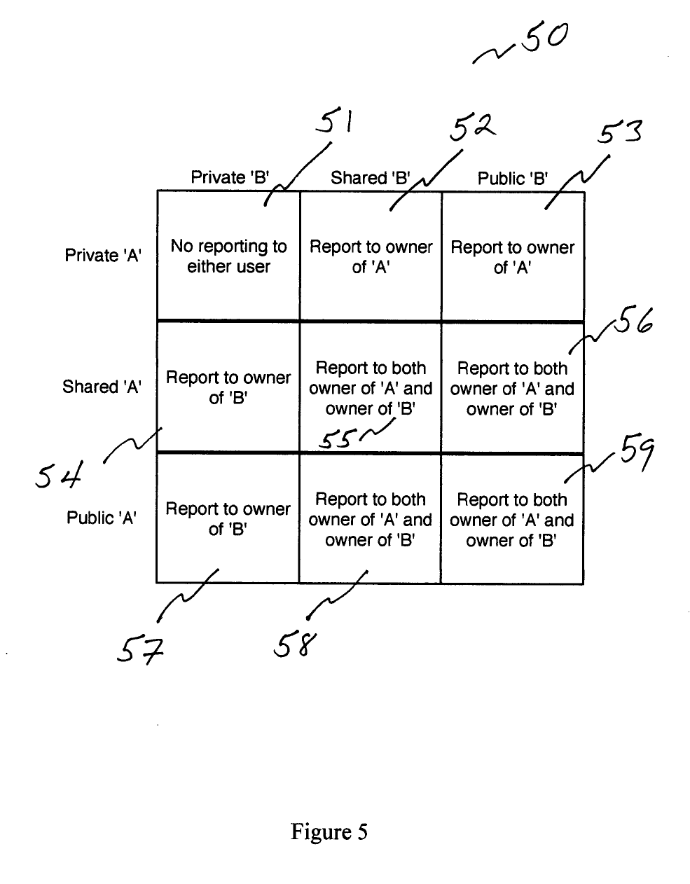

FIG. 5 is a simplified block diagram 50 of a flow diagram according to an embodiment of the present invention. The diagram is merely an example, which should not limit the scope of the claims herein. One of ordinary skill in the art would recognize many other variations, modifications, and alternatives. The present invention provides a method 50 for choosing delivery of insights based on the sharing of the pre-ideas; this example shows two pre-ideas and the resulting reporting while insights from more than two pre-ideas can be easily recognized by one of ordinary skill. If an insight is generated from two pre-ideas that are private then neither pre-idea originator is notified 51. If an insight is generated from a shared pre-idea from user B and a private pre-idea from user A then the insight is only delivered to user A 52; inversely, if an insight is generated from a shared pre-idea from user A and a private pre-idea from user B then the insight is only delivered to user B 54. If an insight is generated from a public pre-idea from user B and a private pre-idea from user A then the insight is only delivered to user A 53; inversely, if an insight is generated from a public pre-idea from user A and a private pre-idea from user B then the insight is only delivered to user B 57. If an insight is generated from a shared pre-idea from user B and a shared pre-idea from user A then the insight is delivered to both user A and B 55. If an insight is generated from a public pre-idea from user B and a shared pre-idea from user A then the insight is delivered to both user A and B 56; inversely, if an insight is generated from a public pre-idea from user A and a shared pre-idea from user B then the insight is delivered to both user A and B 58. If an insight is generated from a public pre-idea from user B and a public pre-idea from user A then the insight is delivered to both user A and B 59.

Although the above has been described in terms of general systems and software, many other variations, alternatives, and modifications can exist. For example, any of the functionality above can be further integrated or even separated in terms of hardware. Alternatively, the functionality can be further integrated or even separated in terms of software. Alternatively, the functionality can be further combined in terms of hardware and software. The functionality can also be separated in terms of a combination of hardware and software. Depending upon the application, other variations can exist.

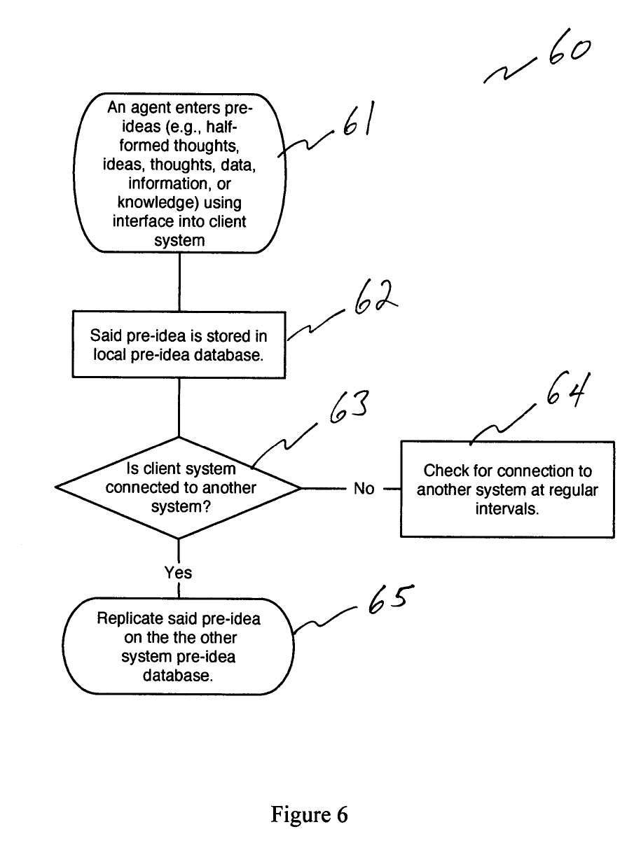

FIGS. 6 though 12 are simplified flow diagrams 60, 70, 80, 90, 100, 110, 120 illustrating methods according to embodiments of the present invention. The diagrams are merely examples, which should not limit the scope of the claims herein. One of ordinary skill in the art would recognize many other variations, modifications, and alternatives.

Referring to FIG. 6, the present invention provides a method 60 for the user to create a pre-idea using the user interface (step 61), which is then stored by the client system in the local pre-idea database (step 62). The client system then checks whether it can see a server in the network (step 63); in an alternate embodiment the client system checks whether it can see another client in the network. If the client system is able to connect to a server in the network then it communicates the pre-idea to the server system and the server system stores the pre-idea in its pre-idea database (step 65); in an alternate embodiment if the client system is able to connect to another client system in the network then it communicates the pre-idea to the client system and the client system stores the pre-idea in its pre-idea database; in an alternate embodiment the client system continues to check at regular intervals for additional server systems and client systems and communicates the pre-idea to the additional server systems and client systems which store the pre-idea in their pre-idea databases. If the client system is unable to connect to a server system in the network then it continues to check on at regular intervals for a server system until it has communicated the pre-idea to a server system (step 64); in an alternate embodiment if the client system is unable to connect to another client system in the network then it continues to check on at regular intervals for a client system until it has communicated the pre-idea to a client system.

Although the above has been described in terms of general systems and software, many other variations, alternatives, and modifications can exist. For example, any of the functionality above can be further integrated or even separated in terms of hardware. Alternatively, the functionality can be further integrated or even separated in terms of software. Alternatively, the functionality can be further combined in terms of hardware and software. The functionality can also be separated in terms of a combination of hardware and software. Depending upon the application, other variations can exist.

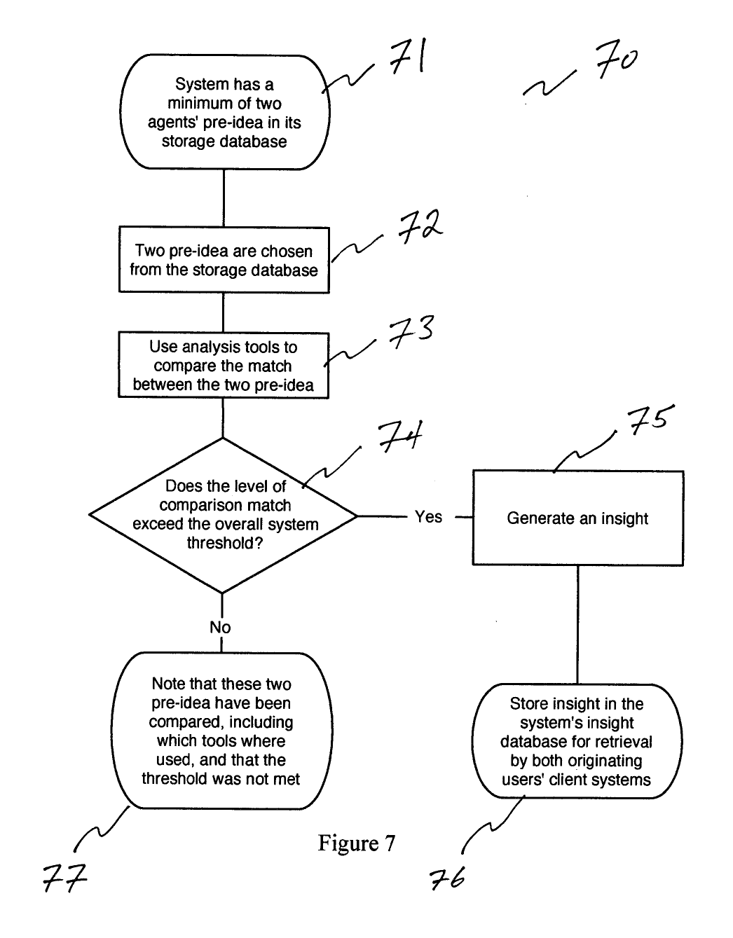

Referring to FIG. 7, the present invention provides a method 70 for using analytics to compare two notes in order to discover and generate an insight. A client or server system begins with at least two pre-ideas in its pre-idea database (step 71). Two pre-ideas are chosen (step 72); the pre-ideas can be chosen using any number of methodologies, including but not limited to, latest first, oldest first, random, ranking of similarity based on pre-analysis, ranking of dissimilarity based on pre-analysis, choice by the user, cost of the pre-idea, value of the pre-idea, payment by either user, payment to either user, popularity of the pre-idea, popularity of either user, or any combination. The system then uses analytics to compare the two pre-ideas (step 73); the analytics can be chosen from the multitude of analyses methods, including, but not limited to, keyword matching, contextual matching, synthetic analysis, or any combination; in a preferred embodiment multiple analytics are applied to the pre-ideas; in a preferred embodiment the results for one set of analysis will allow the system to choose the next analytic method or tool. The system checks whether the analytics produce a match result that meets or exceeds thresholds (step 74); in a preferred embodiment the threshold to be met can be related to one analysis method, multiple methods in combination, differences between a combination of results, at different stages of an analysis chain, or any combination. If the pre-ideas match at a level exceeding a threshold then an insight has been discovered and generated for storage (step 75); at a minimum the generated insight includes the two pre-ideas, the match score, and the analytic uses to obtain the match. The system then stores the insight in the insight database for both originating client systems (step 76) to later display to the users. If no match is found between the pre-ideas using any of the analytics then the system records that these pre-ideas have been compared, which analytics were applied, and that none of the analytics resulted in an acceptable match level (step 77); said pre-ideas can be chosen again for analysis when either or both pre-ideas is updated by a client or server system, when new analytics are available, when the threshold values for analytics are modified, or any combination. In an alternate embodiment the system can choose two or more pre-ideas to analyze.

Although the above has been described in terms of general systems and software, many other variations, alternatives, and modifications can exist. For example, any of the functionality above can be further integrated or even separated in terms of hardware. Alternatively, the functionality can be further integrated or even separated in terms of software. Alternatively, the functionality can be further combined in terms of hardware and software. The functionality can also be separated in terms of a combination of hardware and software. Depending upon the application, other variations can exist.

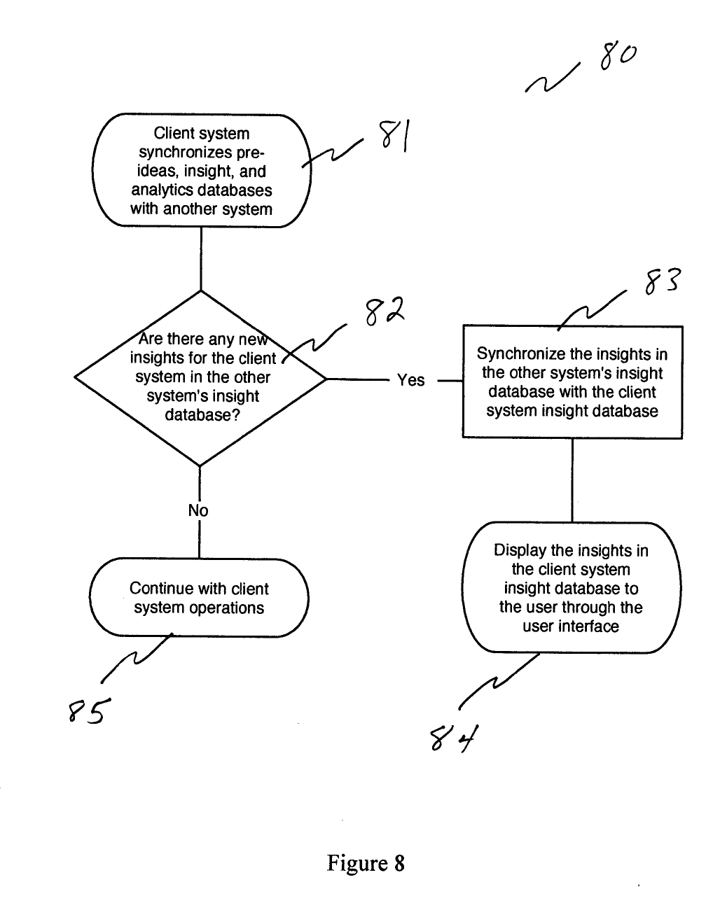

Referring to FIG. 8, the present invention provides a method 80 for the client system to obtain new insights from another system. The client system begins by synchronizing its pre-idea, insight, and analytics database with another system, including a client system or server system (step 81). The client system checks with the other system whether there are any new insights for the client system's user (step 82). If there are new insights for the user of the client system then the client system obtains the insight or insights and stores them in the insight database (step 83). The client system then prepares to display the insight and displays them to the user (step 84); the user can then choose to accept, integrate, ignore, defer, delete, or otherwise review the insight. If no insights are at the remote system for the user of the client system then the client system continues with its normal operations (step 85).

Although the above has been described in terms of general systems and software, many other variations, alternatives, and modifications can exist. For example, any of the functionality above can be further integrated or even separated in terms of hardware. Alternatively, the functionality can be further integrated or even separated in terms of software. Alternatively, the functionality can be further combined in terms of hardware and software. The functionality can also be separated in terms of a combination of hardware and software. Depending upon the application, other variations can exist.

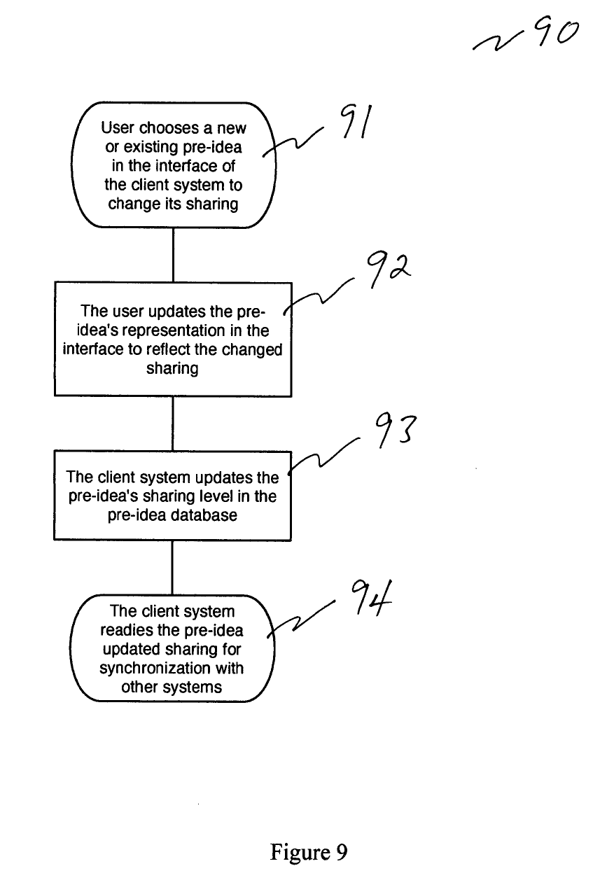

Referring to FIG. 9, the present invention provides a method 90 for the user to change the sharing of a pre-idea on the client system through the user interface. The user selects a pre-idea in the user interface using any of a multitude of interaction methods, including but not limited to, using a mouse, using a touchpad, using a gesture, pointing, using voice, gaze, or any combination (step 91). The user then changes the sharing of the pre-idea in the user interface (step 92); the user could change a private note to be shared with another user, with a set of users, with multiple sets of users, and/or with everyone (e.g., making it public), or, the user could change a public note to be shared with no one (e.g., making it private), with another user, with a set of users, and/or with multiple sets of users, or, the user could change a note that is shared with a set of users or with multiple sets of users to be shared with no one (e.g., making it private) and/or with everyone (e.g., making it public). In an alternate embodiment the levels and details of sharing for pre-ideas can be defined by each user, by the system, by a company, and/or by a community, or any combination, and can further be updated at any time. The client system then updates the sharing for the pre-idea in the pre-idea database (step 93) and prepares the sharing of the pre-idea to be updated with other client systems and server systems (step 94). Referring to FIG. 5, the sharing of insights discovered and generated with the pre-idea whose sharing was updated in 90 may or may not be updated; the choice to update may be automatic, may be left to the user, may be left to the system, and may be changed at a later time.

Although the above has been described in terms of general systems and software, many other variations, alternatives, and modifications can exist. For example, any of the functionality above can be further integrated or even separated in terms of hardware. Alternatively, the functionality can be further integrated or even separated in terms of software. Alternatively, the functionality can be further combined in terms of hardware and software. The functionality can also be separated in terms of a combination of hardware and software. Depending upon the application, other variations can exist.

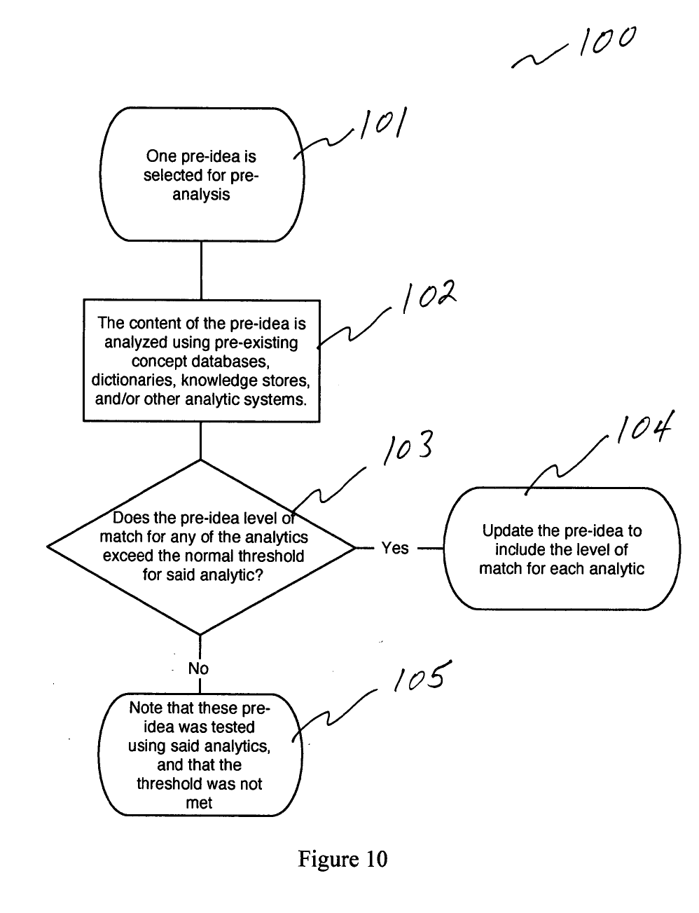

Referring to FIG. 10, the present invention provides a method 100 for the system to pre-analyze an idea. The system chooses a pre-idea for pre-analysis (step 101) using a variety of methodologies, including but not limited to, latest first, oldest first, random, previous pre-analysis, choice by the user, cost of the pre-idea, value of the pre-idea, payment by either user, payment to either user, popularity of the pre-idea, popularity of either user, or any combination. The pre-idea is analyzed using a multitude of methods, including but not limited to, concept databases, dictionaries, knowledge stores, and/or other analytic systems (step 102). The system checks whether the pre-idea meets or exceeds the threshold for any of the analytics (step 103); in a preferred embodiment the threshold to be met can be related to one analysis method, multiple methods in combination, differences between a combination of results between analytics, at different stages of an analysis chain, or any combination. If the pre-idea exceeds a threshold then the system updates the pre-idea to include the analytic and the value (step 104). If no threshold is met then the system records that the pre-idea has been analyzed, which analytics were applied, and that none of the analytics resulted in an acceptable value (step 105); a pre-idea can be chosen again for analysis when the pre-idea is updated by on a client or server system, when new analytics are available, when the threshold values for analytics are modified, or any combination.

Although the above has been described in terms of general systems and software, many other variations, alternatives, and modifications can exist. For example, any of the functionality above can be further integrated or even separated in terms of hardware. Alternatively, the functionality can be further integrated or even separated in terms of software. Alternatively, the functionality can be further combined in terms of hardware and software. The functionality can also be separated in terms of a combination of hardware and software. Depending upon the application, other variations can exist.

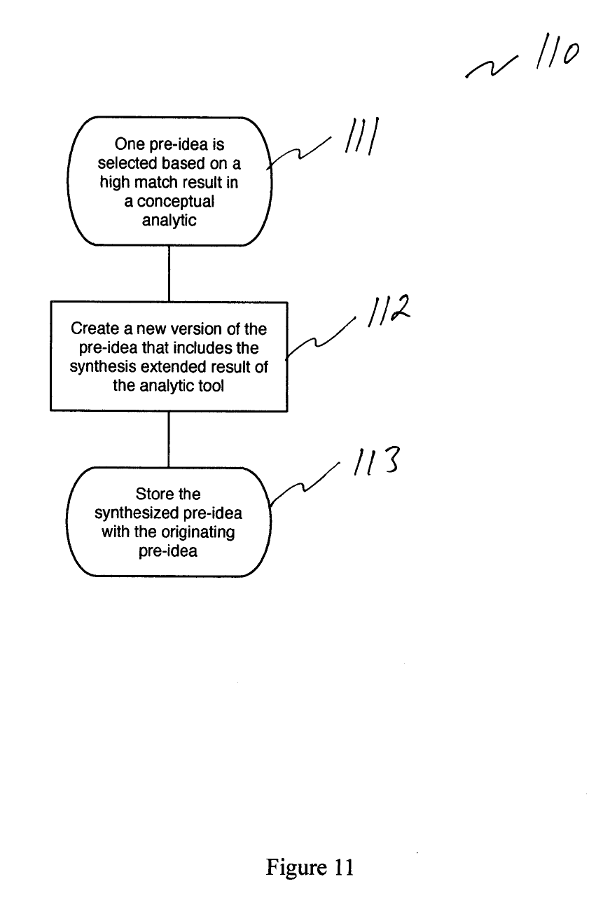

Referring to FIG. 11, the present invention provides a method 110 for an analytic to create a new pre-idea based on synthetic methods. The system chooses a pre-idea to that produced met or exceeded a threshold value during analysis using a conceptual analytic (step 111); in a preferred embodiment the system can draw on tagged information, including both structure and unstructured data sources. The system then uses a lexical expansion method or tool such as WordNet, Cyc, the drfish dataset, and/or any other knowledge database to synthesize another version of the pre-idea (step 112). The system then stores the synthesized pre-idea with the originating pre-idea in the pre-idea database (step 113). In a preferred embodiment the synthesized pre-idea is a separate entry in the pre-idea database, with reference to the originating pre-idea, and is considered equivalent to all pre-ideas once it has been stored.

Although the above has been described in terms of general systems and software, many other variations, alternatives, and modifications can exist. For example, any of the functionality above can be further integrated or even separated in terms of hardware. Alternatively, the functionality can be further integrated or even separated in terms of software. Alternatively, the functionality can be further combined in terms of hardware and software. The functionality can also be separated in terms of a combination of hardware and software. Depending upon the application, other variations can exist.

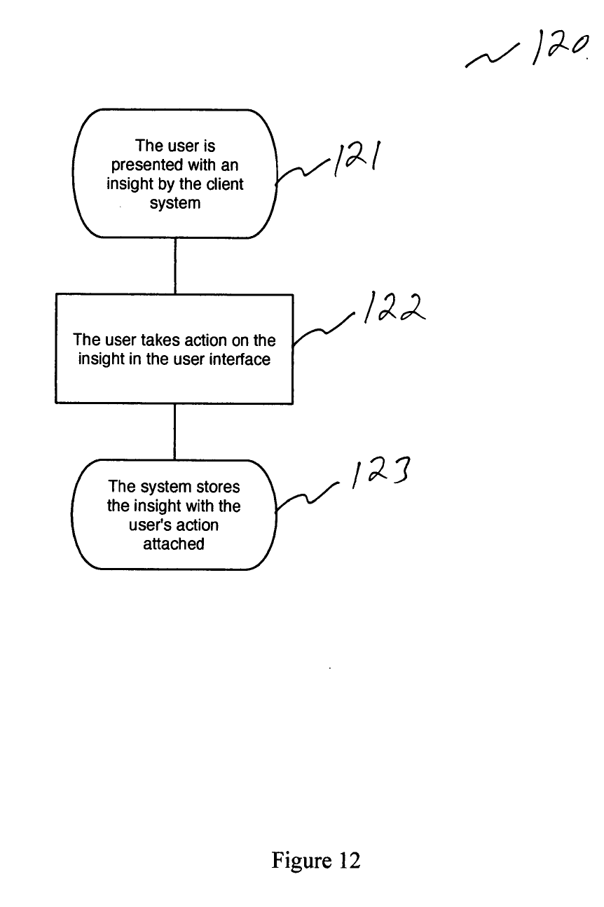

Referring to FIG. 12, the present invention provides a method 120 for presenting an insight to the user. The client system presents an insight to the user through the user interface (step 121). The user can accept, integrate, ignore, defer, delete, or otherwise review the insight, or any combination, using the user interface (step 122). The system stores the user's action or actions with the insight in the insight database (step 123). An insight that is deleted by one of the originating pre-idea user in his or her client system user interface has no effect on the insight that exists in the other originating user's insight database. In a preferred embodiment an insight is never deleted by the system but is retained in the insight database with an indication that the user chose to delete the insight from the user interface. In a preferred embodiment no insights are ever deleted from any insight database in the network, including all client systems and server systems. In an alternate embodiment insights that are deleted by the user from the user interface and that are retained in the insight database are available to the system for analysis to discover and generate additional insights.

Although the above has been described in terms of general systems and software, many other variations, alternatives, and modifications can exist. For example, any of the functionality above can be further integrated or even separated in terms of hardware. Alternatively, the functionality can be further integrated or even separated in terms of software. Alternatively, the functionality can be further combined in terms of hardware and software. The functionality can also be separated in terms of a combination of hardware and software. Depending upon the application, other variations can exist.

Although the above has generally described the present invention according to specific systems, the present invention has a much broader range of applicability. In particular, the present invention is not limited to a particular kind of insight, but can be applied to virtually any type of pre-ideas (e.g., half-formed thoughts, ideas, thoughts, data, information, or knowledge) where an understanding about the working is desired. Thus, in some embodiments, the techniques of the present invention could provide insights about many different types of materials, processes, cells, substances, and genetic processes of all kinds. Of course, one of ordinary skill in the art would recognize other variations, modifications, and alternatives.

What is claimed is:

1. A method for discovering and generating an insight, the method comprising:
an intentioned piece of pre-ideas (e.g., half-formed thoughts, ideas, thoughts, data, information, or knowledge),
generated on a client system by an user,
with a level of sharing; and
under the control of the client system,
packaging the piece of pre-ideas (e.g., half-formed thoughts, ideas, thoughts, data, information, or knowledge) for transfer,
then transferring said packager across a network;
under control of a client or server system, receiving the package;
retrieving a second piece of pre-ideas (e.g., half-formed thoughts, ideas, thoughts, data, information, or knowledge) generated by a user and stored on the client or server system;
comparing the two pieces of pre-ideas (e.g., half-formed thoughts, ideas, thoughts, data, information, or knowledge),
through the use of analytical methods,
discovering a level of matching; and
generating an insight for both originating users comprising both received pieces of data, information, or knowledge along with the level of matching; and
transferring the generated insight to both originating users
whereby the insight is presented to them for further user-defined action.

2. The method of claim 1 wherein the client systems and server systems are integrated on the same machine and the network is a network of peers.

3. The method of claim 1 wherein the pre-ideas have multiple, user-changeable levels of sharing or security.

4. The method of claim 1 wherein the algorithms used for comparison of the pre-ideas are applied in increasing complexity.

5. The method of claim 1 wherein the algorithms chosen by the system for comparison of the pre-ideas are applied based on the results of earlier analysis and/or stages of comparison algorithm.

6. The method of claim 1 wherein the storage of pre-ideas (e.g., half-formed thoughts, ideas, thoughts, data, information, or knowledge) and/or insights are paid for by the user.

7. The method of claim 1 wherein the storage of pre-ideas (e.g., half-formed thoughts, ideas, thoughts, data, information, or knowledge) and/or insights are paid for by the advertising or sponsorship.

8. The method of claim 1 wherein the users are paid for their entry and maintenance of pre-ideas (e.g., half-formed thoughts, ideas, thoughts, data, information, or knowledge) through funds derived from other sources.

9. The method of claim 1 wherein the generation of insights are paid for by the user.

10. The method of claim 1 wherein the generation of insights are paid for by the advertising or sponsorship.

11. The method of claim 1 wherein the users are paid for insights that are generated from one of their pre-ideas and which is accepted by another user. Said payment may be derived funds derived from advertising, sponsorship, recurring fees for system usage, or from individual users.

12. The method of claim 1 wherein a pre-idea has an associated ranking, score, quality, and/or belief, which can be displayed for the user and/or system.

13. The method of claim 1 wherein an insight has an associated ranking, score, quality, and/or belief, which can be displayed for the user and/or system.

14. The method of claim 1 wherein a user action taken on the a pre-idea or insight provides feedback to the system.

15. The method of claim 1 wherein the system is able to generate taxonomies from the pre-ideas and insights.

16. The method of claim 1 wherein the system is able to discover and generate high-value, low-incidence matches.

17. The method of claim 1 wherein the insights discovered and generated by the system are patentable.

18. A method for discovering and generating an insight, the method comprising:
where the system is a marketplace for pre-ideas and insights.

19. The method of claim 18 wherein the insight and pre-idea marketplace leads to the emergence of real-world teams, organizations, or companies to facilitate the marketplace.

20. The method of claim 17 wherein the insight and pre-idea marketplace is global and/or extraterrestrial.
